(19) United States
(12) Patent Application Publication
(10) Pub. No.: US 2012/0023924 A1
(43) Pub. Date: Feb. 2, 2012

(54) VARIABLE HYDRAULIC SYSTEM

(75) Inventors: Brian M. Clark, Seattle, WA (US); Mark Case, Duvall, WA (US); Rainer Leuschke, Seattle, WA (US)

(73) Assignee: GENIE INDUSTRIES, INC., Redmond, WA (US)

(21) Appl. No.: 12/847,034

(22) Filed: Jul. 30, 2010

(51) Int. Cl. F15B 11/17

(52) U.S. Cl. 60/484

(57) ABSTRACT

A hydraulic system is provided with a prime mover connected to a first fixed displacement pump having a maximum flow A, a hydraulic loop connected to a system of valves and actuators, a second fixed displacement pump having a maximum flow B in fluid communication with the loop, an electric machine operable as one of a motor and a generator connected to the second pump and electrically coupled to a battery, and a controller connected to the prime mover and the electric machine. The hydraulic loop is in fluid communication with the first pump with a first check valve. The second pump is arranged in parallel with the first pump.

### TECHNICAL FIELD

The following disclosure relates generally to hydraulic systems with variable flow. In particular, the following disclosure relates to hydraulic transmissions and includes use and modes of operation for vehicle traction and auxiliary systems.

### BACKGROUND

A conventional hydraulics system sometimes employs variable displacement pumps, such as load sensing pumps, when higher efficiency is desired. The variable displacement pumps control flow continuously from zero flow to maximum flow but are more costly than a fixed displacement pumps. In many hydraulic systems, it is also common to use two separate pumps for redundancy purposes.

If a fixed displacement, variable speed pump is used in the conventional hydraulic system, the pump exhibits accelerated wear if operated at low flow rates with high pressures. To prevent wear, the rotational speed of the pumps is maintained above approximately ⅓ of the maximum pump speed. For example, if a pump is capable of 10 gallons-per-minute (GPM), it is operated such that it does not produce less than 3.3 GPM. If flow in the conventional system is required at less than 3.3 GPM, the flow goes through a relief valve to dissipate the difference between 3.3 GPM and the required flow, which wastes the energy by heating the hydraulic fluid.

### SUMMARY

An embodiment of the invention includes a hydraulic system having a prime mover connected to a first fixed displacement pump having a maximum flow A, and a hydraulic loop connected to a system of valves and actuators, with the loop in fluid communication with the first pump with a first check valve. A second fixed displacement pump is in fluid communication with the loop, and the second pump has a maximum flow B. The second pump is arranged in parallel with the first pump. An electric machine is connected to the second pump and electrically coupled to a battery. The electric machine is operable as one of a motor and a generator. A controller is connected to the prime mover and the electric machine.

Another embodiment of the invention includes a vehicle having a prime mover connected to a first fixed displacement pump having a maximum flow A. A hydraulic loop is connected to a system of valves and actuators, and the loop is in fluid communication with the first pump with a first check valve. A second fixed displacement pump is in fluid communication with the loop, and the second pump has a maximum flow B. The second pump is arranged in parallel with the first pump. An electric machine is connected to the second pump, and electrically coupled to a battery. The electric machine is operable as a motor and a generator. A controller is connected to the prime mover and the electric machine. A plurality of traction devices supports a chassis, at least one of plurality of traction devices driven by a hydrostatic motor, the hydrostatic motor in fluid communication with the system of valves and actuators.

Yet another embodiment of the invention includes a hydraulic system having a hydraulic loop connected to a system of valves and actuators using a valve and a first fixed displacement pump in fluid communication with the hydraulic loop. The first pump has a maximum flow A and is connected to a first prime mover. A second fixed displacement pump is in fluid communication with the system of valves and actuators and has a maximum flow B. The second pump is connected to an electric machine operable as a motor to output mechanical power, and operable as a generator to output electrical power to a battery. The first pump and the second pump operate to provide a net flow to the system of valves and actuators, the net flow between negative B flow and positive A+B flow, and the first and second pump each comply with a respective minimum speed requirement.

### BRIEF DESCRIPTION OF THE DRAWINGS

FIG. 1 is a schematic of a variable hydraulic system according to an embodiment; and

FIG. 2 is a schematic of a variable hydraulic system according to another embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

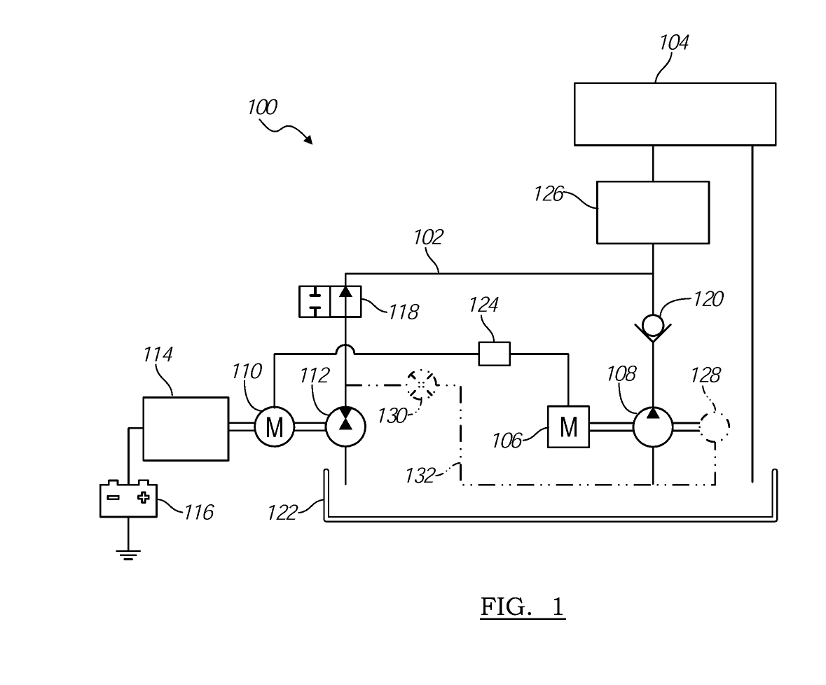

FIG. 1 depicts a variable hydraulic system 100. The system 100 may be used on a vehicle or in a stationary system, and may be used to drive various hydraulic work functions, such as lift and propulsion. In one embodiment, the system of valves and actuators includes hydraulic traction circuit for a vehicle. In another embodiment, the system of valves and actuators includes an aerial lift function for a platform on a vehicle. The drive system 100 may be hybrid powered or electric powered. The drive system 100 has a hydraulic loop 102 in fluid connection with a manifold 104. The manifold 104 contains valves and actuators to provide pressurized fluid for the work functions provided by the system.

A first prime mover 106 is connected to a first pump 108 to provide pressurized fluid to the hydraulic loop 102. The first prime mover 106 may be an internal combustion engine, such as a gasoline or diesel engine, or an electric machine, such as an AC or DC electric motor. If the prime mover 106 is an electric machine, the prime mover 106 is electrically connected to a battery 116. An electric machine 110 is connected to a second pump 112 also in fluid communication with the hydraulic loop 102. The electric machine 110 is connected to an inverter/controller 114, which is in turn connected to a battery 116. In one embodiment, the electric machine 110 is an AC motor and operates as a motor to output power or torque, or as a generator to generate electricity using a power or torque input. The inverter/controller 114 is bi-directional to power the electric machine 110 for operation as a motor, or as a generator to recharge the battery 116.

In one embodiment, the prime mover 106 is a series direct current (DC) motor and the second electric machine 110 is an alternating current (AC) induction motor. In another embodiment, the prime mover and the electric machine 106, 110 are both AC motors, and the prime mover 106 is connected to the battery 116 via an additional inverter/controller (not shown). Alternatively, the prime mover 106 and the electric machine 110 are AC or DC permanent magnet motors, or any four quadrant motor. In another embodiment, the prime mover 106 is an internal combustion engine, such as a spark ignition, diesel, turbine, or others as are known in the art; while the electric machine 110 is any four quadrant motor.

The first and second pump 108, 112 are axial piston pumps, vane pumps, other fixed displacement pumps as are known in the art, or a combination thereof. The fixed displacement pumps 108, 112 may be configured for operation as either a pump to provide pressurized fluid (pumping) or as a turbine, or other device for converting fluid energy to mechanical energy (motoring).

In an embodiment, a valve 118 is provided and switches the pumps 108, 112 between a parallel orientation in the hydraulic loop 102, and disconnecting the second pump 112 from the hydraulic loop 102 when not required for use (as shown), or when running the first pump 110 alone. The parallel orientation, with both pumps pumping, acts to increase the pressure of the pressurized fluid in the hydraulic loop 102. A check valve 120 is located downstream of the outlet of the first pump 108 to prevent backflow into the pump 108 when the system 100 is in the parallel orientation and operating. The hydraulic loop 102 connects to a reservoir 122 which contains the hydraulic fluid.

In an embodiment, the pumps 108, 112 are fixed displacement pumps having variable speeds to produce the required hydraulic flow in the loop 102. A controller 124 controls the speeds of the pumps 108, 112, thereby controlling the flow in the loop 102 between large negative and large positive flows and across zero net flow to the manifold 104. The controller 124 meters low flow in the loop 102 without running the pumps 108, 112 below their minimum speed requirements. The controller 124 also determines the operational modes of the hydraulic system 100.

The loop 102 may be connected to the manifold 104 using a valve 126, or other load connector such as a blocking valve, controlled check valve, or valve attached to an actuator within the manifold 104. The valve 126 acts to control the flow to the manifold 104 as well as provide a load on the flow in the loop 102.

The drive system 100 has several operating modes for the vehicle 100. The modes are controlled using the electronic control module 124. The control module may provide for a user interface, maintenance interface, system control, and the like.

In an embodiment, the first pump 108 has a maximum flow of A gallons per minute when pumping. The second pump has a maximum flow of B gallons per minute when pumping or negative (−) B gallons per minute when motoring, where the positive or negative flow relates to the direction of the fluid. The pumps 108, 112 each have a minimum pump speed, either pumping or motoring, which corresponds to a minimum flow. For example, pump 112 may pump between minimum speed flow, b, and maximum flow B. Pump 112 may also motor between minimum speed flow −b, and maximum flow −B. Zero flow through pump 112 lies between b and −b flow. Any references made to flow below from a pump lie within the possible ranges outlined. References to an increase or decrease in flow are made to the magnitude of the flow, i.e. flow “increases” from −b to −B.

The controller 124 controls the speed and operation of the pumps 108, 112 to create a net flow from the hydraulic loop 102 to the system of valves and actuators 104. The controller 124 varies the speed of the first pump 108 and the speed of the second pump 112 to create a variable net flow between negative B flow and positive A+B flow.

Valve 118 also serves to unload the second pump 112 from the hydraulic loop 102 during a transition operation. A transition operation is when the second pump is changing from a pumping mode to a motoring mode or vice versa. Alternatively, transition operations are when the second pump 112 is changing between a negative and a positive second pump speed, or vice versa. Unloading the second pump 112 during the transition helps to maintain pump life and minimize wear or damage from cycling from a positive pump direction to a negative pump direction.

In another embodiment, the controller 124 operates the first pump 108 (pumping) and the second pump 112 (motoring), such that the net flow from the loop 102 to the system of valves and actuators 104 is the difference between a flow provided by the first pump 108 and a flow received by the second pump 112. The flows provided by pump 108 may be any value between that provided by the minimum pump speed and the maximum flow A. The flow provided by the second pump 112 may be any value between that provided by the minimum pump speed (in reverse or motoring) and the maximum motoring flow, −B.

In a further embodiment, the prime mover 106 drives the first pump 108 above the minimum pump speed to provide a flow to the hydraulic loop 102. The second pump 112 receives flow from the hydraulic loop 102 and motors above minimum pump speed to drive the electric machine 110 as a generator to charge the battery 116. The net flow from the hydraulic loop 102 passes through the valve 126 and to the system of valves and actuators 104. The net flow to the system of valves and actuators 104 is metered by the controller 124 varying the speed of at least one of the first pump 108 and the second pump 112.

In another embodiment, the prime mover 106 drives the first pump 108 to pump to provide flow to the hydraulic loop 102 and system of valves and actuators 104. The electric machine 110 drives the second pump 112 as a pump to also provide flow to the hydraulic loop 102 and system of valves and actuators 104. The pumps 108, 112 may be metered by the controller 124 to each provide flow between that provided by their respective minimum pump speeds and maximum flow, A or B respectively.

In one example, the first pump 108 is pumping at or above its minimum pump speed requirement. The second pump 112 is motoring at or above its minimum pump speed requirement. The flow pumped from the first pump 108 is offset by the flow required by the second pump 112, and the net flow to the system of valves and actuators 104 is at or near zero flow. This may be used when the battery 116 needs charging and no flow is required by the system of valves and actuators 104.

In another embodiment, the valve 118 is closed such that only the first pump 108 can provide flow from the hydraulic loop 102 to the system of valves and actuators 104. The prime mover 106 drives the first pump 108 to provide flow to the hydraulic loop 102 and the system of valves and actuators 104. Flow through the second pump is prevented due to the valve 118 closure. The first pump 108 may provide flow from its minimum pump speed up to the maximum flow for the pump, A.

In an embodiment, the first pump 108 is inactive, and the valve 118 is open such that the first pump 108 and second pump 112 are in parallel. The electric machine 110 drives the second pump 112 (pumping) between the minimum pump speed of the pump, and up to the maximum flow of the pump, B. The pump 112 provides flow to the hydraulic loop 102 and the system of valves and actuators 104. Flow from the second pump 112 is prevented from backflowing into the first pump 108 by the check valve 120.

In another embodiment, the system of valves and actuators 104 has an external load, such as a lift function fully raised or a propulsion system at the top of a hill, or in other words the system 104 has an amount of stored potential energy. When the system of valves and actuators 104 releases the potential energy into flow energy, the system 104 provides flow to the hydraulic loop 102, which thereby drives the second pump 112 (motoring) to drive the electric machine 110 as a generator to charge the battery 116. The first pump 108 is inactive as the flow from the system of valves and actuators 104 cannot flow through the pump 108 due to the check valve 120.

In the case that the prime mover 106 is an engine, the engine 106 may run at one of a plurality of constant speeds, run at varying speeds, or run at a constant speed, or power output, or torque output, such as one that would maximize fuel efficiency for example.

The engine 106 is often operated at an approximately steady output to increase engine efficiency. When there is excess power output by the engine 106 that is not required as flow by the system of valves and actuators 104, the excess power may be transferred through the hydraulic loop 102. The engine 106 drives the first pump 108, which provides flow to the loop 102. Any excess flow not required by the system of valves and actuators is directed to the second pump 112 which motors to power the electric machine 110 as a generator to charge the battery 116.

Alternatively, when there is insufficient power from the engine 106 to provide flow from the first pump 108 to the system of valves and actuators 104, additional power may be provided by the electric machine 110 driving the second pump 112 (pumping) to augment the flow in the hydraulic loop 102 and maintain a generally steady engine output. This ability to augment the flow with the second pump 112 allows for a smaller engine 106 than is typical. The changes in required flow may be managed by the electric machine 110 acting as a motor or a generator in concert with the second pump 112, while the engine 106 runs at a generally stabilized power output within a desired range.

In another embodiment, a third pump 128 is connected to the engine 106. The third pump 128 is also hydraulically connected to a valve 130 via hydraulic line 132. To start an inactive engine 106, the electric machine 110 drives the first pump to provide flow. Valve 112 is open, while valve 118 may be opened or closed. The pump 128 is driven as a motor to start the engine 106. The third pump 128 may be connected to the first pump 108 through a torque coupling such as a splined connection, a piggybacked connection, or the like. Alternatively, the third pump 128 may be driven directly by the engine 106.

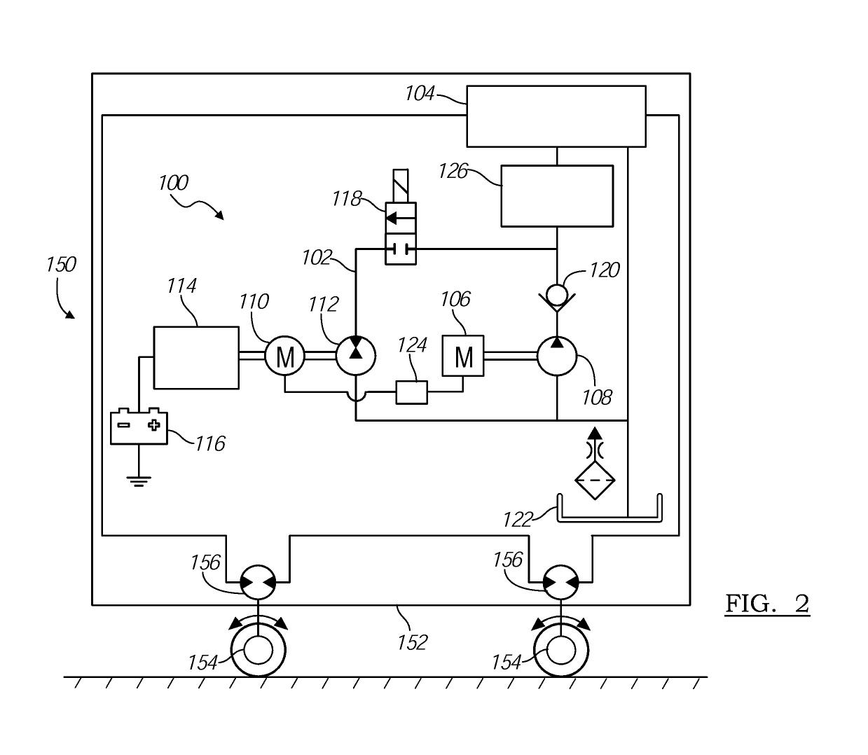

FIG. 2 illustrates another embodiment which includes a vehicle 150. Types of vehicles 150 that may use a hydraulic drivetrain system include hydrostatic front end loaders, skid steer loaders, wheeled excavators, and the like. The vehicle 150 has a hydraulic system 100, as described above with respect to FIG. 1, supported by a chassis 152. The chassis 152 of the vehicle 150 is supported by traction devices 154 in contact with an underlying surface.

The traction devices 154 for the vehicle 150 may be any number of wheels or may be equipped with other fraction devices, such as tracks. The system of valves and actuators 104 provides hydraulic fluid to hydrostatic drive motors 156 connected to the fraction devices 154 to propel the vehicle 150 across the ground. The hydrostatic motors 120 may be arranged in series or in parallel. In one embodiment, each of the traction devices 154 is individually driven by a respective torque source, such as a hydrostatic drive motor 156. In another embodiment, a portion of the traction devices 154 are driven using additional electric machines. In an alternate embodiment, only one hydrostatic drive motor 156 is connected to a pair of traction devices 154 using a differential or the like.

In a first operating mode, only pump 108 operates to provide pressurized fluid to the hydraulic loop 102 and the system of valves and actuators 104, while the other pump 112 remains inactive, and the valve 118 remains closed. The system of valves and actuators 104 uses the pressurized fluid provided by one of the pumps 108, 112 to drive hydrostatic motors 156 attached to traction devices 154, and/or provide a lifting or other work function for the vehicle 150.

In a second operating mode, valve 118 switches to an open position, and both pumps 108, 112 operate in parallel within the drive system 100 to provide pressurized fluid to the hydraulic loop 102 and the valves and actuators 104.

In a third operating mode, with valve 118 open, the first pump 108 provides pressurized fluid to the hydraulic loop 102 and system of valves or actuators 104, while excess flow is used to motor the second pump 112 to rotate the electric machine 110 as a generator, and charge the battery 116. The net flow in the hydraulic loop 102, which may also be used by the valves and actuators 104 for drive and/or lift operations, is the difference between the first flow from the first pump 108 and the second flow from the second pump 112 motoring. If no flow is required by the valves and actuators 104, the second pump 112 may use all of the first flow to motor and charge the battery 116 in a generation mode.

In a fourth operating mode, stored potential energy is recovered from either the lift or work function or the drive function of the system of valves and actuators 104, for example when a platform is returning from a raised to a stowed position or the vehicle 150 is travelling down a sloped surface S. The second pump 112 is driven as a motor by flow returning from the valves and actuators 104, through valve 118 in the loop 102 and before it reaches the reservoir 122. The second pump 112 drives the electric machine 110 as a generator to charge the battery 116.

For example, in operation, when a high flow rate through the loop 102 is required, one or both pumps 108, 112 provide flow. When low flow is required in the loop 102, the first pump 108 operates above its minimum speed, while the second pump 112 motors at or above the minimum speed of pump 112 to generate mechanical energy. Since the first pump 108 is adding flow rate, pressure, or energy to the flow through the loop 102, and the second pump 112 is removing flow rate, pressure, or energy from the flow in the loop 102, the net flow to the manifold 104 is the difference between the two flows.

For example, if the first pump 108 pumps at 4 GPM and the second pump 112 motors at 3.3 GPM, the net flow is 0.7 GPM. Since the second pump 112 is motoring, the second pump 112 is acting as a turbine or generator, which supplies electric current charge to the battery 116 through the electric machine 110 acting as a generator. If the first pump 108 is powered by an engine 106, the generated current charges the system battery 116. If the first pump 108 is powered by an electric motor in place of the engine 106, the generated current from the second pump 112 will reduce the amount of electric power the first pump 108 requires from the battery 116. In this configuration, the second pump 112 functions as a variable set point pressure relief valve.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. Additionally, features of various implementing embodiments may be combined to form further embodiments of the invention.

What is claimed is:

1. A hydraulic system comprising:
a prime mover connected to a first fixed displacement pump, the first pump having a maximum flow A;
a hydraulic loop connected to a system of valves and actuators, the loop in fluid communication with the first pump with a first check valve;
a second fixed displacement pump in fluid communication with the loop, the second pump having a maximum flow B, wherein the second pump is arranged in parallel with the first pump;
an electric machine connected to the second pump, and electrically coupled to a battery, the electric machine operable as one of a motor and a generator; and
a controller connected to the prime mover and the electric machine.

2. The hydraulic system of claim 1 wherein a net flow from the hydraulic loop to the system of valves and actuators is variable between negative B flow and positive A+B flow by varying the speed of the first pump and the speed of the second pump.

3. The hydraulic system of claim 2 wherein the first pump operates and second pump operates in reverse such that the net flow to the system of valves and actuators is the difference between a flow provided by the first pump and a flow received by the second pump.

4. The hydraulic system of claim 2 wherein the system of valves and actuators includes at least one valve connecting the hydraulic loop to an actuator moving a load; and
wherein the prime mover drives the first pump to provide flow to the hydraulic loop, and the second pump receives flow from the hydraulic loop to drive the electric machine as a generator to charge the battery; and
wherein the net flow to the system of valves and actuators is metered by varying the speed of at least one of the first pump and the second pump.

5. The hydraulic system of claim 2 wherein the prime mover drives the first pump to provide flow to the hydraulic loop and system of valves and actuators, and the electric machine drives the second pump to provide flow to the hydraulic loop and system of valves and actuators.

6. The hydraulic system of claim 2 wherein the first pump and second pump are in compliance with their respective minimum pump speed requirements, and net flow to the system of valves and actuators is zero.

7. The hydraulic system of claim 2 wherein the prime mover drives the first pump to provide flow to the hydraulic loop and the system of valves and actuators, and flow through the second pump is prevented.

8. The hydraulic system of claim 2 wherein the first pump is inactive, and the electric machine drives the second pump to provide flow to the hydraulic loop and the system of valves and actuators.

9. The hydraulic system of claim 2 wherein the system of valves and actuators provides flow to the hydraulic loop, thereby driving the second pump to drive the electric machine as a generator to charge the battery, and the first pump is inactive.

10. The hydraulic system of claim 2 further comprising a valve for unloading the second pump from the hydraulic loop during a transition operation between a negative and a positive second pump speed.

11. The hydraulic system of claim 1 wherein the prime mover further comprises an engine.

12. The hydraulic system of claim 11 wherein the second pump uses at least some flow in the hydraulic loop to drive the electric machine as a generator to charge the battery.

13. The hydraulic system of claim 11 wherein the system of valves and actuators includes at least one valve connecting the hydraulic loop to an actuator for moving a load;
wherein the valve hydraulically disconnects the actuator from the hydraulic loop, the prime mover drives the first pump to provide flow to the hydraulic loop, and the second pump receives flow from the hydraulic loop to drive the electric machine as a generator to charge the battery.

14. The hydraulic system of claim 11 wherein the engine is operated within a desired output range by using the second motor as one of a motor and a generator to stabilize the engine output.

15. The hydraulic system of claim 1 wherein the prime mover further comprises a second electric machine.

16. The system of claim 11 further comprising a valve in fluid communication with the second pump and one of the first pump and a third hydraulic pump, the third pump connected to the engine;
wherein flow is directed from the second pump through the valve to drive one of the first pump and the third pump as a motor to start the engine.

17. The hydraulic system of claim 2 wherein the system of valves and actuators further comprises a hydraulic traction circuit for a vehicle.

18. A vehicle comprising:
a prime mover connected to a first fixed displacement pump, the first pump having a maximum flow A;
a hydraulic loop connected to a system of valves and actuators, the loop in fluid communication with the first pump with a first check valve;
a second fixed displacement pump in fluid communication with the loop, the second pump having a maximum flow B, wherein the second pump is arranged in parallel with the first pump;
an electric machine connected to the second pump, and electrically coupled to a battery, the electric machine operable as a motor and a generator;
a controller connected to the prime mover and the electric machine; and
a plurality of traction devices supporting a chassis, at least one of plurality of traction devices driven by a hydrostatic motor, the hydrostatic motor in fluid communication with the system of valves and actuators.

19. The vehicle of claim 18 wherein a net flow from the hydraulic loop to the system of valves and actuators is variable between negative B flow and positive A+B flow by varying the speed of the first pump relative to the speed of the second pump.

20. A hydraulic system comprising:
a hydraulic loop connected to a system of valves and actuators using a valve;
a first fixed displacement pump in fluid communication with the hydraulic loop, the first pump having a maximum flow A, the first pump connected to a first prime mover; and
a second fixed displacement pump in fluid communication with the system of valves and actuators, the second pump having a maximum flow B, the second pump connected to an electric machine operable as a motor to output mechanical power, and operable as a generator to output electrical power to a battery;
wherein the first pump and the second pump operate to provide a net flow to the system of valves and actuators, the net flow between negative B flow and positive A+B flow, and the first and second pump each comply with a respective minimum speed requirement.
